(19) United States
(12) Patent Application Publication
(10) Pub. No.: US 2026/0160385 A1
(43) Pub. Date: Jun. 11, 2026

(54) Low-Profile Expandable Grip and Stand

(71) Applicants: Jacob Epstein, Concord, MA (US); Lukas Scheurer, Providence, RI (US)

(72) Inventors: Jacob Epstein, Concord, MA (US); Lukas Scheurer, Providence, RI (US)

(21) Appl. No.: 19/179,792

(22) Filed: Apr. 15, 2025

Related U.S. Application Data
(60) Provisional application No. 63/634,338, filed on Apr. 15, 2024.

(51) Int. Cl. F16M 13/04; F16M 13/06

(52) U.S. Cl. CPC F16M 13/04; F16M 13/06

(57) ABSTRACT

A grip for a mobile device includes a frame having at least one magnet for coupling the grip to a mobile device or to a case of a mobile device. The grip further includes a strap configured to transition from a collapsed configuration to an expanded configuration in which the strap forms a loop configured to receive a user's finger. The frame defines a partially enclosed opening through which the strap is configured to pass during this transition from the collapsed to the expanded configuration.

### PRIORITY

This patent application claims priority from provisional United States patent application number 63/634,338, filed Apr. 15, 2024, entitled, “Low Profile Expandable Strap Grip & Stand,” and naming Jacob Epstein as inventor, the disclosure of which is incorporated herein, in its entirety, by reference.

### FIELD OF THE INVENTION

Illustrative embodiments generally relate to accessories for a mobile device and, more particularly, illustrative embodiments relate to a device that allows users to grip and stand their phone up for viewing.

### BACKGROUND

Mobile devices are frequently used every day for work and entertainment. To make holding (or using) a phone more comfortable and stable, mobile accessory makers have invented a wide variety of grips, straps, rings, knobs and other mechanical devices for the user to get a better grip on their phone while interacting with it. In general, there is a relationship between the bulk of these accessories and their utility. Very thin, sleek accessories are not bulky on a phone, yet provide the user with limited utility (e.g., a thin strap to put a finger through). Larger accessories offer more volume for the user to grip or prop up their phone on a flat surface, but they add uncomfortable bulk to the phone.

### SUMMARY

In accordance with an embodiment, a grip for a mobile device includes a frame having at least one magnet for coupling the grip to a mobile device or to a case of a mobile device. The grip further includes a strap configured to transition from a collapsed configuration to an expanded configuration in which the strap forms a loop configured to receive a user's finger. The frame defines a partially enclosed opening through which the strap is configured to pass during this transition from the collapsed to the expanded configuration.

In some embodiments, the frame is configured such that the partially enclosed opening becomes fully enclosed by a surface of the mobile device or the case of the mobile device when the grip is magnetically coupled to the device or case. In such a configuration, the strap is effectively surrounded by the mobile device or case when positioned within the opening. Additionally, the grip may include a ferromagnetic shim disposed between the magnet and a top surface of the frame to modulate the magnetic field. The grip may also feature a lock configured to engage with a portion of the frame in the expanded configuration, wings extending laterally from the strap, and an epoxy coating on the magnet with a thickness between about 0.005 mm and 0.05 mm. In certain embodiments, the strap is secured to the frame via a rivet, and the frame may be formed as a circular conductive structure that includes a non-metallic gap or insert configured to interrupt the electrical path around the frame. In one low-profile embodiment, the total thickness of the grip in the collapsed configuration is 3 mm or less.

In accordance with another embodiment, a method of operating an expandable grip for a mobile device includes providing an expandable grip having a base configured to couple with a mobile device or its case, and a strap that is partially retained within the base and movable between a collapsed configuration and an expanded configuration where the strap forms a loop. The method further includes coupling the expandable grip to the mobile device or case, and transitioning the strap from the collapsed configuration to the expanded configuration.

In various embodiments of the method, transitioning comprises applying a force to the strap using a finger of a user to reposition the strap from the collapsed to the expanded configuration. More specifically, the strap may be pressed or slid through an opening in the base using a single finger. The method may also include inserting a finger into the loop formed by the expanded strap. Additionally, the expanded strap may be used to support the mobile device in an inclined position on a flat surface. In some configurations, the grip includes a locking feature configured to resist return to the collapsed configuration, and the method may include deforming a portion of the strap to disengage the locking feature and subsequently returning the strap to the collapsed configuration. The method may further include magnetically coupling the expandable grip and mobile device to an external ferromagnetic surface for hands-free use.

In accordance with another embodiment, a system includes a mobile device or a case associated with a mobile device that includes a device-side magnetic coupling portion, and a grip configured for use with the mobile device or case. The grip includes a frame having a bridge, a corresponding magnetic coupling portion housed within the frame, and a strap that is coupled to the frame and movable between a collapsed configuration and an expanded configuration in which the strap forms a loop. The strap is configured to pass through an opening during transition between configurations, where the opening is formed in part by the bridge and a surface of the mobile device or case when the grip is magnetically coupled to it.

The system may also include a ferromagnetic shim disposed between the magnet coupling portion and a top surface of the frame. The strap may further include a lock configured to engage a portion of the frame when in the expanded configuration.

An expandable grip for use with a mobile device or a case associated with the mobile device includes a frame configured to couple to a surface of the device or case, and a strap having a first end and a second end. The strap is partially retained within the frame and movable between a collapsed configuration, in which the strap lies substantially flat, and an expanded configuration, in which the strap forms a loop to define a finger-receiving area. The grip also includes a bridge formed as part of or within the frame, wherein the strap passes beneath the bridge during movement between the two configurations.

In some embodiments, the frame includes a magnet array configured to magnetically couple the frame to the mobile device or case. A ferromagnetic shim may be positioned adjacent to the magnet array and configured to attenuate magnetic flux on a first side of the expandable grip relative to a second side, where the first side faces an external object and the second side faces the mobile device. The shim may comprise a steel material having a thickness between approximately 0.05 mm and 0.20 mm to achieve this selective attenuation.

The strap may include a stop configured to limit retraction into the frame and define a maximum loop size in the expanded configuration. In certain embodiments, the stop is positionally adjustable along the strap to allow user customization. The strap may also include a lock configured to interfere with the bridge in the expanded configuration to resist unintentional collapse. The lock may be disengaged by deformation of the strap, allowing the strap to pass back beneath the bridge. In some cases, the lock has a contoured projection or bump formed in the strap, configured to engage the bridge when the strap is arced, providing resistance to inadvertent return to the collapsed state.

The expandable grip may further include a pair of wings extending laterally from the strap, configured to provide a grasping surface in the expanded configuration. These wings may be positioned off-center in the collapsed configuration and move toward a more central position as the strap expands.

To facilitate wireless charging, the frame may include a plug or non-conductive material portion that interrupts electrical conductivity, thereby reducing interference with wireless power transmission. The magnet array may also include one or more magnets having a surface coating selected to improve adhesion, scratch resistance, or shock absorption. The coating may have a thickness between approximately 0.001 mm and 0.050 mm.

In certain designs, the frame includes one or more holes aligned with the magnets to locally modify magnetic flux characteristics. The strap may be mechanically anchored to the frame using an anchor, such as a tab or projection that passes through an opening in the strap. This anchor may be bent to lock the strap in place and reinforced using a rigid plate.

In some embodiments, the strap is retained between the bridge and the surface of the mobile device or case, taking advantage of the device surface to complete the containment structure. The strap may also be semi-rigid, allowing the grip to support the device in an inclined position when used as a stand. Finally, the total thickness of the grip in its collapsed configuration may be between about 1.5 mm and about 3 mm, supporting the grip's use in slim and low-profile applications.

It should be apparent, that illustrative embodiments provide a number of advantages. For example, illustrative embodiments advantageously provide a very thin mobile accessory that sticks to the back of the mobile device (or a case thereof), and which can be activated very quickly (e.g., expanded and collapsed). In various embodiments, the accessory advantageously provides a very stable comfortable grip in the expanded configuration. Furthermore, in various embodiments, the accessory advantageously may be used to prop up the mobile device on a flat surface when in the expanded configuration, such that the accessory operates similar to a “kickstand”.

Another advantage of illustrative embodiments is that in the collapsed configuration, the accessory is extremely thin, such that it adds minimal thickness to the overall mobile device. Another advantage of illustrative embodiments is that it can be expanded very to a larger comfortable grip to provide mechanical stability when holding the mobile device quickly and easily (e.g., with the use of one hand). Yet another advantage of illustrative embodiments is that the accessory can be quickly and easily collapsed back to an extremely thin state. Another advantage of illustrative embodiments is that, in the expanded configuration, it can be used as a rigid “kickstand” to prop up a mobile device for viewing on a flat surface. Another advantage of illustrative embodiments is that the accessory may allow the user to stick their phone to ferromagnetic objects while still providing a slim profile.

### BRIEF DESCRIPTION OF THE DRAWINGS

The advantages of the embodiments described herein, together with further advantages, may be better understood by referring to the following description taken in conjunction with the accompanying drawings. The drawings are not necessarily to scale; emphasis is instead generally being placed upon illustrating the principles of the embodiments.

Those skilled in the art should more fully appreciate advantages of various embodiments of the invention from the following “Description of Illustrative Embodiments,” discussed with reference to the drawings summarized immediately below.

FIG. 1 schematically shows a cutoff side view of the expandable grip in the expanded configuration in accordance with illustrative embodiments of the invention.

FIG. 2 schematically shows a cutoff side view of the expandable grip in the collapsed configuration in accordance with illustrative embodiments of the invention.

FIG. 3A schematically shows a non-cutoff top view of the expandable grip in accordance with illustrative embodiments of the invention.

FIG. 3B schematically shows a cutoff top view of the expandable grip in accordance with illustrative embodiments of the invention.

FIG. 4 schematically shows a user using the expandable grip with a mobile device in accordance with illustrative embodiments of the invention.

FIG. 5 schematically shows a side view of the expandable grip being used as a stand in accordance with illustrative embodiments of the invention.

FIGS. 6A-6B schematically show an alternative embodiment of the expandable grip in accordance with illustrative embodiments of the invention.

FIGS. 7A-7C schematically show a cutoff side view of an anchor in accordance with illustrative embodiments of the invention.

FIG. 8 schematically shows a top view of the expandable grip with a strap with wings in accordance with illustrative embodiments of the invention.

FIG. 9 schematically shows a user using the wings of the expandable grip in accordance with illustrative embodiments of the invention.

FIGS. 10A-10B schematically show a cutoff side view of two embodiments with magnetic Flux lines in accordance with illustrative embodiments of the invention.

FIG. 11 schematically shows a user removing a mobile device having the expandable grip from a ferromagnetic object in accordance with illustrative embodiments of the invention.

FIG. 12 schematically shows a top view of the expandable grip with holes in accordance with illustrative embodiments of the invention.

FIG. 13 schematically shows a side-view of the expandable grip with wings in the expanded configuration while attached to a mobile device in accordance with illustrative embodiments of the invention.

FIG. 14 schematically shows a cutoff side view of the expandable grip with a plug in accordance with illustrative embodiments of the invention.

FIG. 15 schematically shows a top view of the expandable grip with the plug in accordance with illustrative embodiments of the invention.

FIGS. 16A-16C schematically show a cutoff side view of a segment of the frame showing different configurations of magnets and their associated attachment and protection features in accordance with illustrative embodiments of the invention.

FIG. 17 schematically shows a cutoff side view of the expandable grip in the collapsed position with a lock in accordance with illustrative embodiments of the invention.

FIG. 18 schematically shows a cutoff side view of the expandable grip in the expanded position with a user pushing the top of the expanded strap in accordance with illustrative embodiments of the invention.

FIG. 19 schematically shows a cutoff side view of the expandable grip in the expanded position with a user pushing the side of the expanded strap in accordance with illustrative embodiments of the invention.

FIG. 20 shows a process of using the expandable grip in accordance with illustrative embodiments.

### DETAILED DESCRIPTION

The expandable grip is a mobile accessory configured to attach to a mobile device or to a case of the mobile device. The expandable grip is operable to provide enhanced stability during user handling (i.e., gripping), and may further function as a kickstand to support the mobile device in an upright orientation on a flat surface for hands-free viewing. The expandable grip includes a gripping portion that is repositionable between a collapsed configuration and an expanded configuration. The gripping portion may include, for example, a strap, band, or loop-forming member. For convenience, the gripping portion is referred to herein as the strap. Details of illustrative embodiments are discussed below.

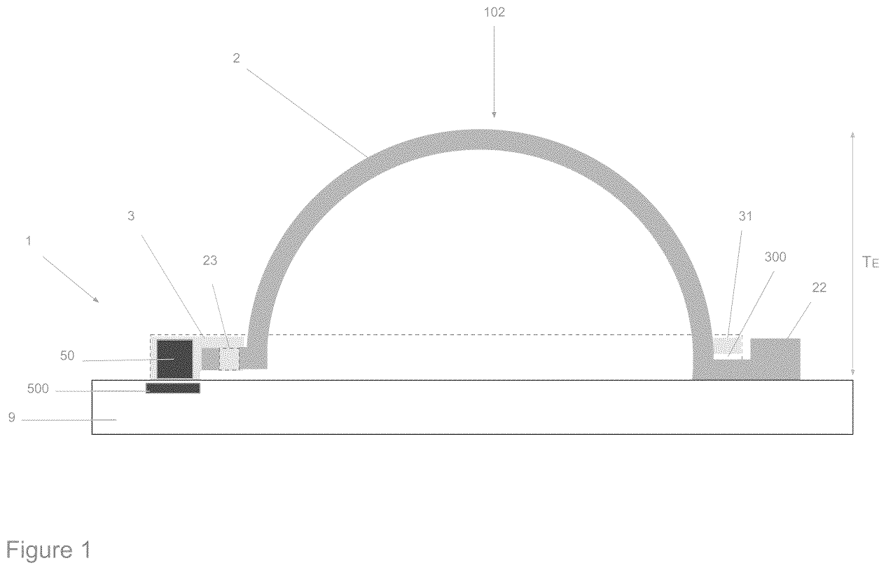

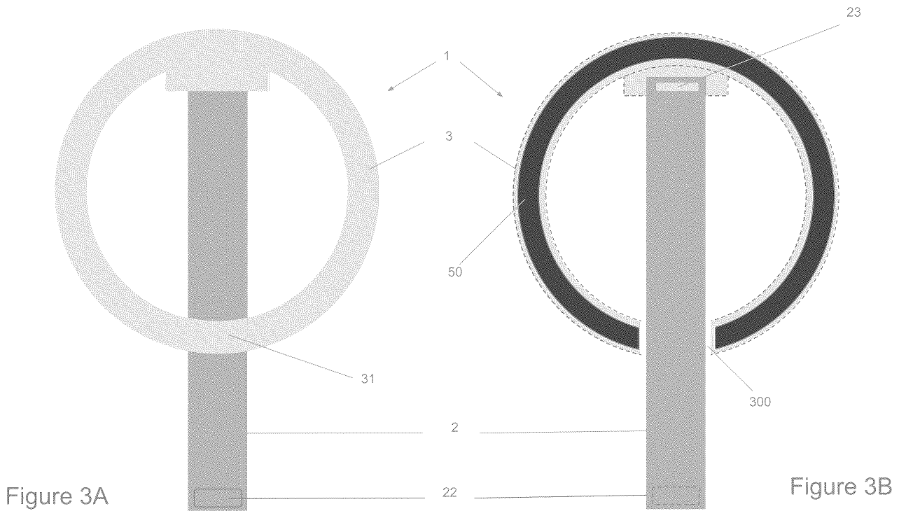

FIG. 1 shows a cutoff side view of the expandable grip 1 in the expanded configuration in accordance with illustrative embodiments (also referred to as being in an expanded state). Here, the grip 1 is coupled with a mobile device 9. The strap 2 is pulled through an opening 300 defined by a “bridge” 31 in a frame 3 of the grip 1 to form a semi-rigid loop 102 that defines a finger-receiving area. The frame 3 (also referred to as a grip main body 3, chassis 3 or base 3) is better shown in FIGS. 3A-3B below. In FIG. 1, the strap 2 is near or at the maximum expanded configuration, where it cannot form a larger loop 102. The grip 1 has a total thickness T_{E} in the expanded configuration that is greater than a total thickness T_{C} in the collapsed configuration. In various embodiments, the total thickness T_{E} in the expanded configuration may be about 20 mm. However, it should be apparent that illustrative embodiments may modify the size of the loop to various ends, (e.g., so that the loop is big enough for a finger). On one side, the strap 2 has an anchor 23 which keeps that side in place. On the other side, the strap 2 has a stop 22 which prevents any more of the strap 2 from entering the frame 3 and joining the loop area.

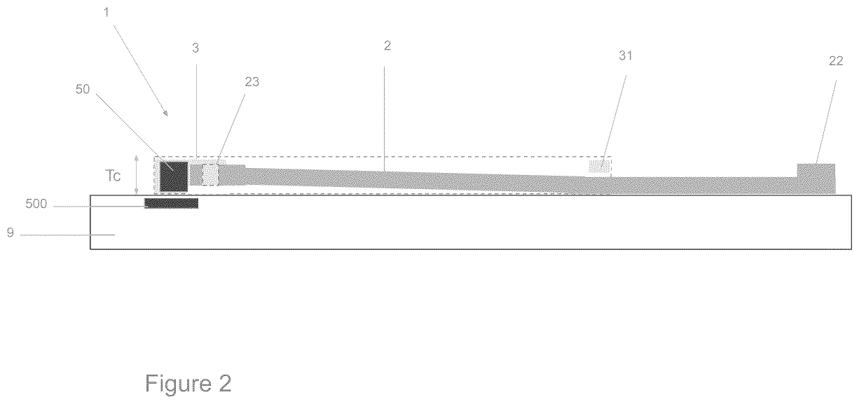

FIG. 2 shows a cutoff side view of the expandable grip 1 in the collapsed configuration in accordance with illustrative embodiments (also referred to as being in a collapsed state). As shown, the strap 2 no longer forms the loop 102. In the figure, the strap 2 has been pushed flat so that, when compared to FIG. 1, more of the strap is outside of the frame 3 (i.e., outside of the perimeter formed by the frame).

As used herein, the term “frame” may refer to any structural portion of the grip 1 that supports or retains components such as the strap, magnets, or attachment features. The frame may include a rigid body, a flexible body, or a portion of a device case into which grip 1 components are integrated.

FIGS. 1-2 collectively illustrate side views of the expandable grip 1 transitioning between the expanded configuration (FIG. 1), in which the strap 2 forms the semi-rigid loop 102 for user engagement, and a collapsed configuration (FIG. 2), in which the strap 2 lies substantially flat and does not form the loop 102. These figures demonstrate the range of motion and structural limits of the strap 2 as it moves between its operational (expanded) and stowed (collapsed) states.

As used herein, references to the grip coupling to, attaching to, or contacting a mobile device (or surface thereof) are intended to include both direct attachment to the mobile device itself and attachment to a case associated with the mobile device. The attachment may occur either through the case (e.g., via magnets that attract through the case material) or directly to the case (e.g., when the case includes magnetic material or a compatible attachment surface). For brevity, the term “mobile device” will be used throughout, and should be understood to include both the device itself and any case associated therewith, unless otherwise specified.

In the collapsed configuration, the strap 2 lies substantially flush against a surface of the mobile device or device case. In this configuration, the grip 1 does not protrude significantly from the surface and does not form a space suitable for receiving the user's finger. This configuration is generally intended for storage or non-use and may provide a low-profile aesthetic or reduce interference with pockets, bags, or wireless charging.

In the expanded configuration, the strap 2 repositions or is displaced away from the surface of the mobile device to form a raised loop, arch, or handle-like structure that defines a space through which the user's finger may be inserted. Notably, the term “expanded” as used herein does not imply that the material itself undergoes physical expansion, elongation, or stretching. Rather, it refers to a change in configuration in which the strap 2 occupies a different spatial position, such as forming a loop or elevated portion relative to the device surface, thereby transitioning to a usable or engaged state.

As used herein, the terms “collapsed configuration” and “expanded configuration” refer to distinct positional states of the grip element relative to the mobile device. These terms are not intended to suggest any change in the physical dimensions of the material itself, but rather describe the geometric arrangement of the grip element during use and non-use.

FIG. 3A shows a top view of the expandable grip 1 in accordance with illustrative embodiments. Here it can be seen that the anchor 23 is not visible as it may be within (and covered by) the frame 3. The bridge 31 is visible as this may be effectively just the top of the frame 3 with a gap beneath it for the strap 2. When coupled to the mobile device, the bridge 31 contains the strap on one side, and the mobile device contains the strap on the other side. Advantageously, this allows the grip 1 to use less material, making the overall grip 1 thinner. However, in some embodiments, the bridge 31 may fully surround the strap 2 and have added thickness. During use, and while the expandable grip 1 is coupled to the mobile device, the strap 2 can be considered as passing under the bridge 31.

FIG. 3B is a bottom view of the expandable grip 1 of FIG. 3A. Here it can be seen that the bridge 31 is not visible since it is under the strap 2. The strap 2 is passing through the opening 300 defined by the frame 3 (e.g., a recess) in the frame 3. As visible in FIG. 3B, the opening 300 may advantageously be a partially enclosed opening. The partially enclosed opening 300 is structurally bounded on at least one side, but not fully surrounded or sealed by the surrounding material of the frame 3 (e.g., the bridge 31). In various illustrative embodiments, the bridge 31 forms a partially enclosed opening 300 through which the strap 2 passes. The bridge 31 may provide coverage over the strap 2 on a top or lateral side, while the bottom of the opening 300 remains open, such that the mobile device 9 or its case forms the opposing boundary when the grip 1 is coupled thereto. This configuration allows the strap 2 to be guided and retained by the bridge 31, while maintaining open entry and exit paths for the strap 2 to transition between collapsed and expanded configurations. Unlike traditional grip 1 designs that fully encapsulate the strap 2 within a closed channel or tunnel, this partially enclosed structure reduces overall thickness and simplifies one-handed operation, while still mechanically constraining the strap 2 in use. The partially enclosed opening 300 advantageously leverages the surface of the mobile device 9 to complete the strap 2 containment path, minimizing material usage and maximizing compactness in the collapsed configuration.

The opening 300 may be configured to conform entirely, or at least partially, to the dimensions of the strap 2 in the regions where it structurally bounds the strap 2, such that in various embodiments, the opening 300 provides at least lateral or top-side constraint to guide and retain the strap 2 during movement between the collapsed and expanded configurations, and also when the grip 1 is being used (e.g., coupled to the mobile device 9). In some embodiments, the opening 300 may fully surround or enclose the strap 2 along its perimeter, thereby providing continuous structural constraint during use.

The anchor 23 is visible and is shown as a piece of the frame 3 that passes through a hole in the strap 2. The purpose of the anchor 23 is to permanently hold the end of the strap 2 in place. The strap 2 may be attached at the anchor 23 using a variety of well-known methods including ultrasonic welding, glue, overmolding or mechanical entrapment. In various embodiments, the grip 1 includes a radial magnet 50 array. The magnet or magnets 50 may be encapsulated inside of the frame 3 and used to couple the expandable grip 1 to the mobile device magnetically. The one or more magnets 50 form a magnetic coupling portion configured to magnetically secure the expandable grip to the mobile device 9, device case, or external ferromagnetic surface.

As shown in FIGS. 1-3B, the grip 1 may include a stop 22. The stop 22 may be integrally formed with the strap 2 or may be implemented as a separate component affixed to the strap 2—for example, a pin, a snap-on component, or an object secured via adhesive. In some embodiments, the stop 22 may be positionally adjustable along the strap 2, allowing the size of the resulting semi-rigid loop 102 formed by the strap 2 in the expanded configuration to be customized by the user. Although the stop 22 is depicted in the figures as extending in the Z-direction (i.e., perpendicular to the device surface), it may alternatively extend in the X-Y plane (i.e., laterally across the surface) and still function effectively. The primary function of the stop 22 is to prevent the strap 2 from being fully pulled into the frame 3, which would otherwise prevent the strap 2 from forming a stable loop for gripping.

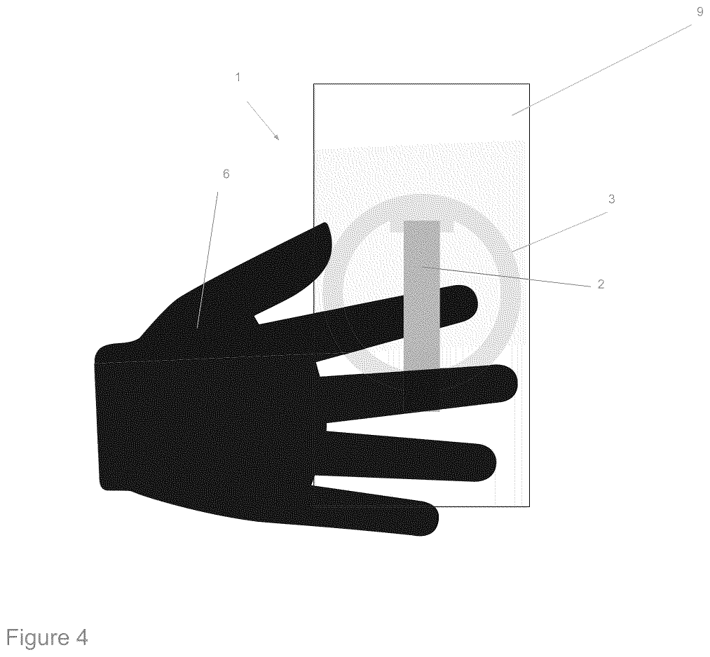

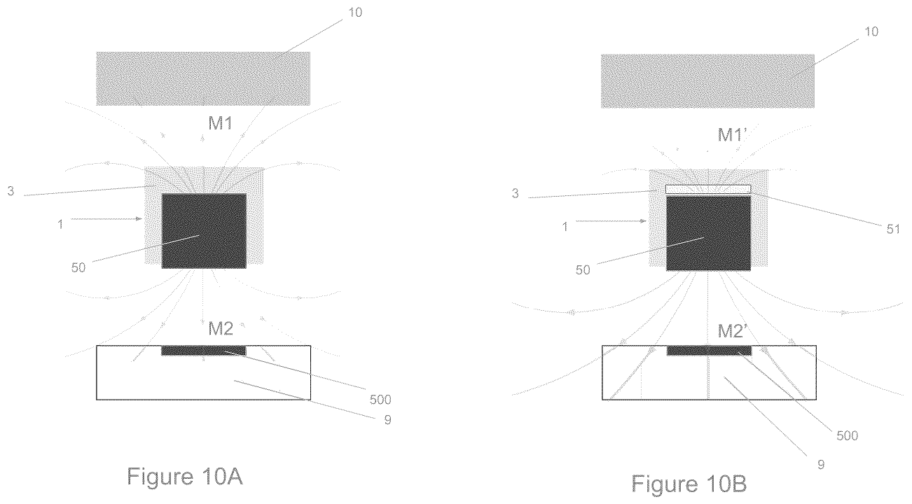

FIG. 4 schematically shows a user 6 using the expandable grip 1 with the mobile device 9 in accordance with illustrative embodiments. As shown, the expandable grip 1 is attached to the mobile device 9 and the user 6 has a finger inserted into the loop of the expanded strap 2. The expandable grip 1 may be coupled to the mobile device 9 using the magnets 50. For example, the mobile device 9 may have Integral magnets 500 (such as MagSafe or Qi2 like that shown in FIGS. 10A-10B). It may also couple to a magnetic case or a metal ring adapter designed to attract magnets. The expandable grip 1 may couple to the mobile device 9 using other methods, such as adhesives. Alternatively, the expandable grip 1 may be formed as part of a mobile device case. FIG. 4 illustrates that the expandable grip 1 couples to the mobile device 9 and a user 6 realizes mechanical stability (i.e. a grip) by inserting their finger under the expanded strap 2.

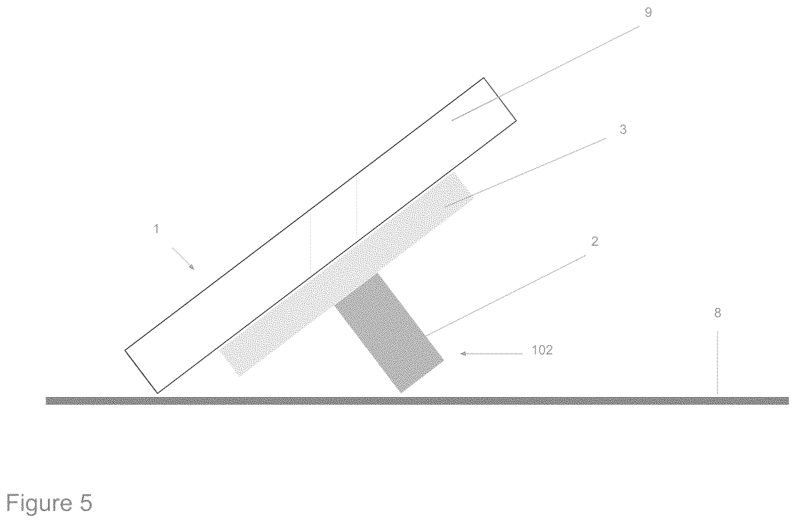

FIG. 5 schematically shows a side view of the expandable grip 1 being used as a stand in accordance with illustrative embodiments. As shown in FIG. 5, the expandable grip 1 may also be used as a stand to prop up the mobile device 9 for viewing on a Flat Surface 8. The strap 2, which may be semi-rigid, may then form the semi-rigid loop 102 when expanded. This semi-rigid loop 102 may support the weight of the mobile device 9 when on a flat surface (e.g., angled on the table).

A notable advantage of various embodiments of the expandable grip 1 optimizations that result in a low profile (i.e. thin grip 1). As shown in FIG. 2, the overall thickness T_{C} in the collapsed configuration of illustrative embodiments may be as low as the total thickness of the strap 2 plus the small thickness of the bridge 31. Illustrative embodiments may thus provide a phone grip and stand that is less than 4 mm in total thickness T_{C} in the collapsed configuration. In some embodiments, depending on the materials used, the total thickness T_{C} in the collapsed configuration may be under 3 mm. Illustrative embodiments shown as configured in the figures are operable as grips and stands with a thickness T_{C} of less than 2.5 mm.

In some embodiments, the expandable grip 1 may be configured to also operate as a stand. However, in some embodiments, the expandable grip 1 may not be configured to operate as a stand. This may relax the material requirements of the strap 2 (e.g., the strap 2 does not need to be semi-rigid) resulting in a thinner strap 2, and overall even thinner grip.

An additional advantage of the bridge 31 is that it enables the user 6 to easily transition the strap 2 into the expanded configuration using a simple pushing or pulling motion. Because the strap 2 passes freely through an opening under the bridge 31, the user can perform this action with one hand. In contrast, other loop-forming embodiments may constrain the strap 2 within a track or channel, or otherwise restrict its movement, making the transition to the expanded configuration more difficult. Furthermore, such alternative embodiments may position additional material beneath the strap 2, increasing the overall thickness of the grip 1—an outcome that may be undesirable in applications where a low-profile form factor is preferred.

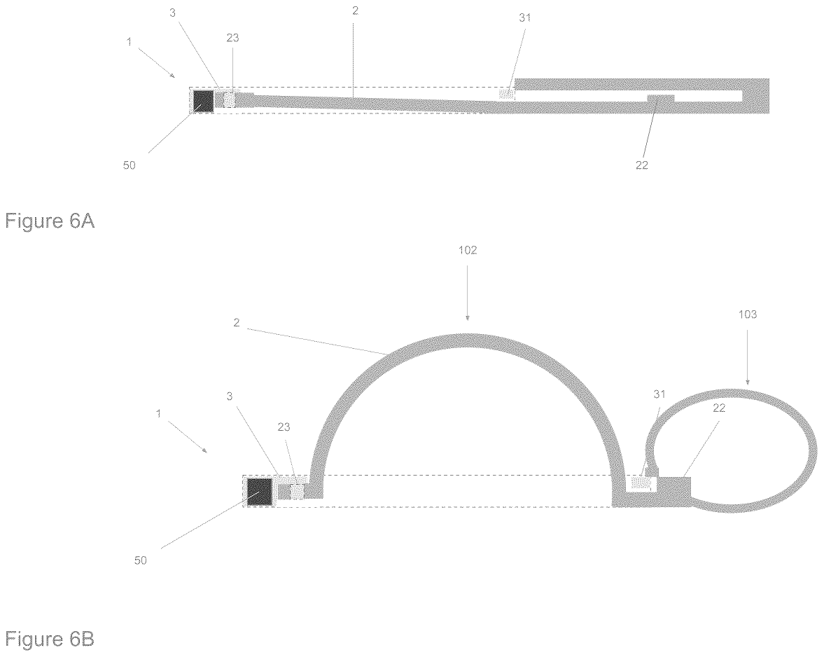

FIGS. 6A-6B schematically show an alternative embodiment of the expandable grip 1 in accordance with illustrative embodiments. Here the expansion of the expandable grip 1 strap 2 results in a second semi-rigid loop 103 to be used for a second finger. The strap 2 may extend beyond the stop 22 and may be looped back to the frame 3 (e.g., near the bridge 31). As shown in FIG. 6A, the strap 2 may still be formed or assembled in a flat configuration and it is the expansion of the device that pulls both the primary loop 102 and the secondary loop 103 open. Although FIGS. 6A-6B shows the strap 2 looped back to the frame 3, it should be understood that the strap 2 may also loop back to another point on the strap 2 which is inside the frame 3 to accomplish a similar double loop.

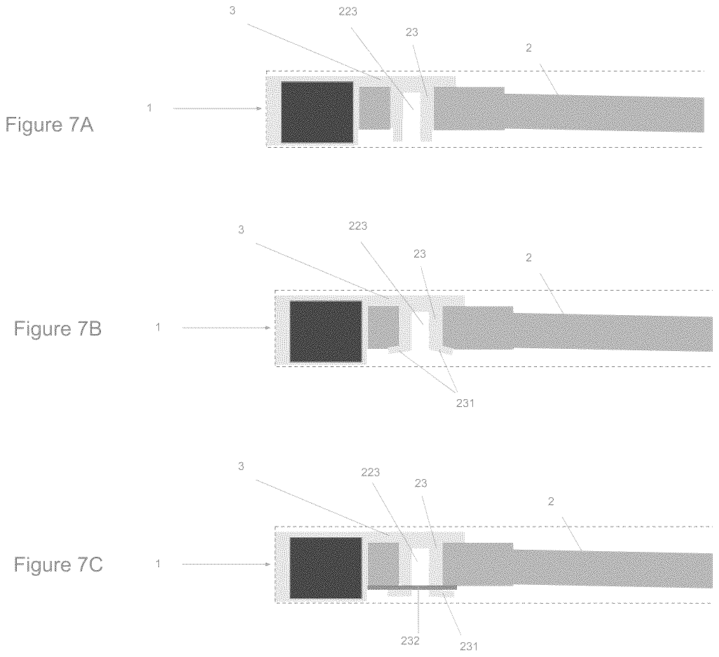

FIGS. 7A-7C schematically show a cutoff side view of the anchor 23 in accordance with illustrative embodiments. The anchor 23 is configured to strongly attach the strap 2 to the frame 3. In some embodiments the strap 2 may have a Hole 223 or holes in it to facilitate a mechanical connection. As shown, at least one piece of the frame 3 may pass through a section of the strap 2. If the Hole(s) 223 in the strap 2 are sized properly, this could create a press-fit style connection where the strap 2 was coupled to the frame 3 at the anchor 23 by friction. To enhance the connection shown in FIG. 7A, the anchor 23 may be sized so that it passes through the strap 2 and is then bent by a manufacturing or assembly process as shown in FIG. 7B. The anchor 23 acts similar to a rivet or bent tab style connection where the frame 3 material is mechanically transformed to lock in the strap 2. An anchor bend 231 may lock in the strap 2. Finally, in FIG. 7C it's shown that the mechanical connection shown in FIG. 7B can be further enhanced by using a Rigid Plate 232. Here the bridge bend 231 is pushing against a larger Rigid Plate 232 which in turn is locking in a large portion of the strap 2.

It can be seen in FIGS. 7A-C that the frame 3 material can be used to accomplish this style bridge anchor if it was formed from a malleable material, such as metal or plastic. Although the anchor 23 is shown in the figures as being integrally part of the frame 3, it could be a separate component such as a rivet that passes through the frame or a welded or sonically welded component that accomplishes the same function mechanically. It can also be seen in the figures that a chemical bonding agent may be used in addition to or in lieu of mechanical connections.

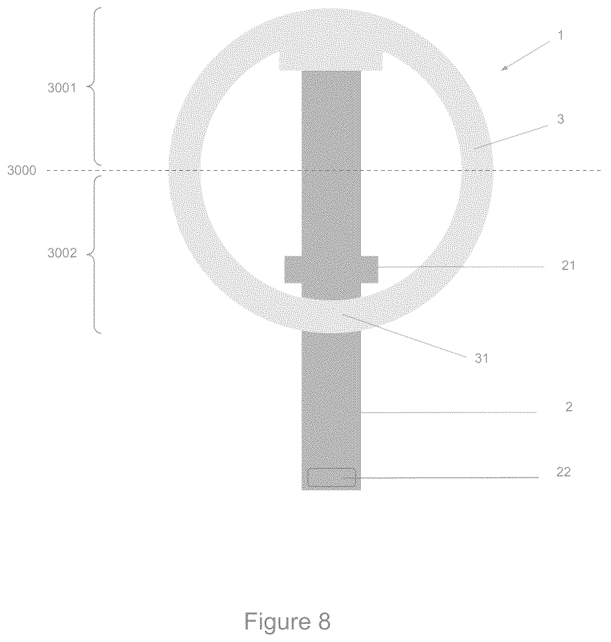

FIG. 8 schematically illustrates a top view of an embodiment of the expandable grip 1 having the strap 2 with wings 21, in accordance with illustrative embodiments. This embodiment is similar to that shown in FIGS. 3A-3B, but includes the wings 21 extending from the strap 2 to assist the user 6 in securely holding the phone 9, particularly when the user is holding the phone sideways (e.g., for taking a selfie). In the collapsed configuration, the wings 21 are positioned off-center (i.e., off centerline 3000 that separates an upper portion 3001 from a lower portion 3002), near the lower portion 3002 of the frame 3—adjacent to the region through which the strap 2 passes, such as a bridge 31, channel, or opening. However, as the strap 2 is transitioned into the expanded configuration, the wings 21 move upward toward the centerline 3000 of the frame 3. This shifting position provides a more centralized and ergonomic grip point, enhancing usability when the expanded strap 2 is not used as a finger loop.

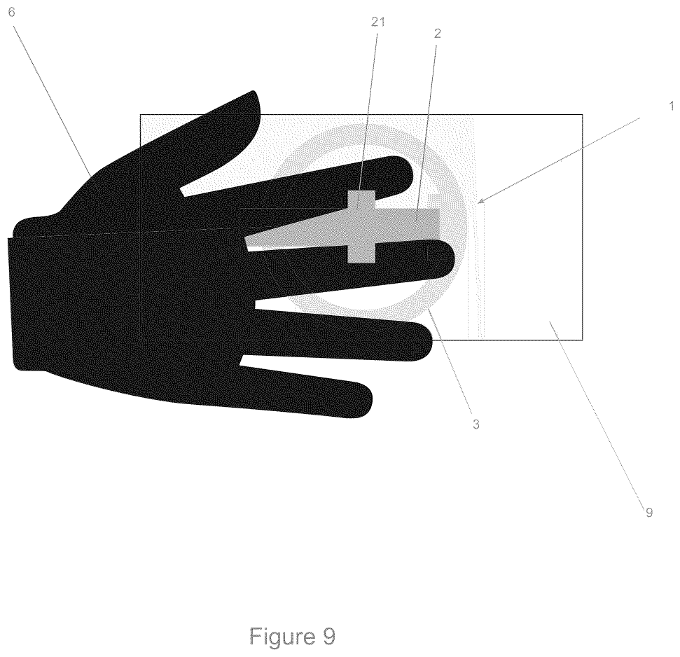

FIG. 9 schematically shows a user using the wings 21 of the expandable grip 1 in accordance with illustrative embodiments. The user 6 has places their fingers under the wings 21 while the strap 2 is in the expanded position. It can be seen in the figure how these wings 21 aid the user 6 to hold their phone 9 in a rotated position vs that shown in FIG. 4. In this configuration, the user 6 likely does not place their finger through the loop formed by the strap 2.

FIGS. 10A-10B schematically show a cutoff side view of two embodiments with magnetic Flux lines from the magnet 50 Array of the frame 3 sub-assembly in accordance with illustrative embodiments. Specifically, FIG. 10A shows a cross section of a portion of the grip 1 and includes a representation of the magnetic Fields M1 and M2. In illustrative embodiment such as those shown in FIG. 10A, it is assumed that the frame 3 is formed from material that does not block magnetic fields (i.e. plastic or aluminum) and therefore the magnetic Fields M1, M2 emanates from both sides of the magnet 50 equally as represented by the flux diagrams in the figure.

Both FIGS. 10A and 10B show portions of the expandable grip 1 with the mobile device 9 below and Ferromagnetic block (Block) 10 above. The figures also show the mobile device 9 having Integral magnets 500 like that in the iPhone (i.e. MagSafe). One can consider an infinite number of force values acting on the expandable grip 1 in the figure, depending on the size and strength of the magnets 50, the Integral magnets 500 and size of the block 10.

FIG. 10B shows an alternative assembly where a Ferromagnetic shim (Shim) 51 is used to dampen or attenuate the magnetic Field M1′ and increase the magnetic Field M2′. Illustrative embodiments provide the ferromagnetic shim 51 to cause the expandable grip 1 to magnetically couple more strongly to the mobile device 9 and less strongly on the opposite side (i.e. towards the block 10) when there are both a device 9 and a block 10 in close proximity. However, the shim 51 can be tuned such that there is still some residual magnetic Field M1′ when installed so that there is some attraction between the expandable grip 1 and the block 10.

In some embodiments, the magnet array 50, when used without the ferromagnetic shim 51, may cause the expandable grip 1 to magnetically couple too strongly to an external ferromagnetic object, such as the block 10. For example, if the expandable grip 1 includes only magnets and is placed in contact with a metallic surface (e.g., a steel refrigerator) on the side opposite the mobile device 9, the magnetic attraction to that surface may exceed the magnetic coupling force with the mobile device 9 itself—particularly when the mobile device 9 includes a non-ferromagnetic casing. As a result, when attempting to separate the expandable grip 1 from the external object 10, the grip 1 may remain adhered to the external surface and peel away from the mobile device 9 instead. Use of the shim 51 in such configurations allows magnetic field tuning to reduce magnetic coupling on the outward-facing side (i.e., toward block 10) while maintaining or enhancing coupling to the mobile device 9.

In contrast, a relatively thick ferromagnetic shim 51 may attenuate the magnetic field M1′ to such an extent that little or no magnetic attraction remains between the expandable grip 1 and the external object (e.g., block 10). To achieve a balanced magnetic response, the shim 51 may be dimensioned to selectively modulate the field strength. For example, in some embodiments, a steel shim with a thickness of approximately 0.1 mm—comparable in feel to aluminum foil—has been found to effectively regulate the magnetic field to fall within a desirable range. In such configurations, the shim 51 enables reliable magnetic coupling between the expandable grip 1 and the mobile device 9 (e.g., via embedded magnets in the phone or case), while still permitting sufficient residual attraction to external ferromagnetic surfaces, such as a refrigerator or metal plate (Block 10). The inventors have found that a steel shim 51 having a thickness between about 0.05 mm and about 0.20 mm can provide this “goldilocks” effect: allowing the grip 1 to couple securely to the mobile device 9 without being unintentionally pulled away when attached to another magnetic or ferromagnetic surface.

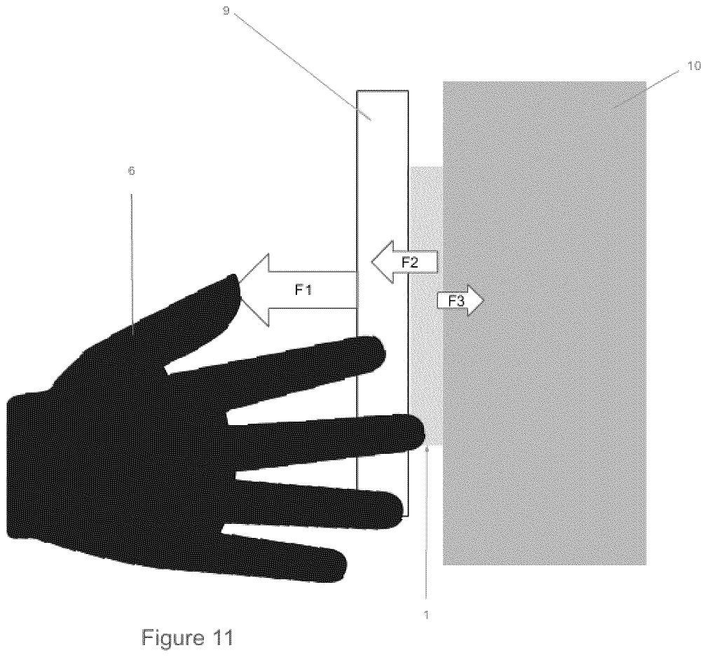

This concept is further illustrated in FIG. 11 which shows three relevant Force Lines F1, F2, F3. FIG. 11 schematically shows the user removing a mobile device 9 having the expandable grip 1 from a ferromagnetic object 10 in accordance with illustrative embodiments of the invention. In the figure, a phone 9 is magnetically coupled with the expandable grip 1. The expandable grip 1 is in turn also magnetically coupled with the block 10. This function may be useful, for example, in a commercial gym to suspend a phone 9 to a piece of gym equipment, or at home to a refrigerator. The block 10 in the figures is meant to represent any external ferromagnetic mass.

As shown in FIG. 11, the user 6 applies a pulling force F1 directed away from both the expandable grip 1 and the external object (block 10). The relative magnitudes of the force vectors F1, F2, and F3 (as illustrated in the figure) indicate that the user-applied force F1 exceeds both the magnetic coupling force F2 between the expandable grip 1 and the mobile device 9, and the magnetic coupling force F3 between the expandable grip 1 and the block 10. Due to the inclusion of the ferromagnetic shim 51, the magnetic attraction between the expandable grip 1 and the mobile device 9 (F2) is stronger than the attraction between the expandable grip 1 and the block 10 (F3). As a result, when the user pulls the mobile device 9 away, the expandable grip 1 remains attached to the device 9 rather than detaching and staying coupled to the external object 10.

Additionally, or alternatively, to further reduce the magnetic coupling force F3 between the expandable grip 1 and the block 10, the frame 3 may be formed with increased material thickness to provide greater magnetic insulation between the magnets 50 and the external surface 10. However, this approach may be undesirable, as it increases the overall thickness of the expandable grip 1. By contrast, incorporating a thin shim 51 provides a more efficient means of tuning magnetic performance without compromising the low-profile design of the grip 1.

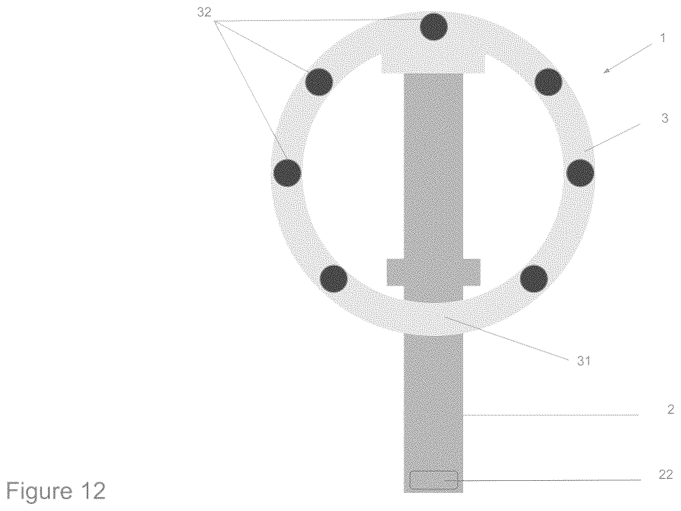

FIG. 12 schematically shows a top view of an alternative embodiment of the expandable grip 1 that dampens the magnetic field in accordance with illustrative embodiments of the invention. The expandable grip 1 may have a frame 3 formed from a magnetic blocking material such as steel, and/or holes 32 which expose the magnetism of the underlying magnets 50. The holes 32 may be actual holes in the frame 3 (i.e. air) but could be composed of any non-magnetic blocking material such as plastic, aluminum, some types of stainless steel, etc. It can be seen that by adding holes 32, the magnetic Field M1 on the top of the expandable grip can be tuned to have the right amount of magnetism such that it can have similar product features to the grips 1 shown in FIGS. 10A-B and FIG. 11.

The force vectors (e.g., F1, F2, F3) and magnetic field lines (M1, M1′, M2, M2′) illustrated in the figures are schematic and not necessarily drawn to scale or with precise physical accuracy. These graphical representations are provided solely for explanatory purposes to aid in understanding the relative interactions among components. No limitation on the scope of the illustrative embodiments should be inferred based on the specific appearance, length, direction, or magnitude of any such lines shown in the figures.

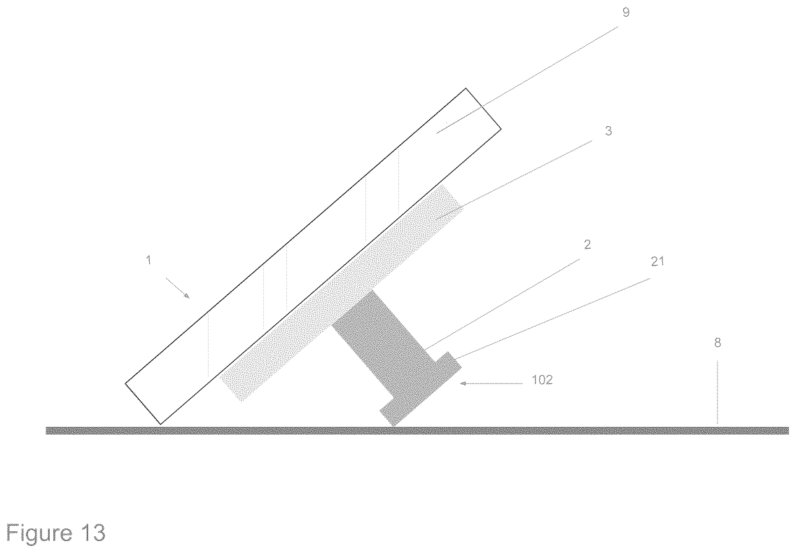

FIG. 13 schematically shows a side-view of the expandable grip 1 with wings 21 in the expanded configuration while attached to the mobile device 9 in accordance with illustrative embodiments of the invention. The expandable grip 1 in FIG. 13 is similar to the grip 1 in FIG. 8 and FIG. 9. If the wings 21 are positioned such they are roughly centered when the expandable grip 1 is expanded, this advantageously increases the standing viewing angle over that which is shown in FIG. 5. This may be advantageous to the stand feature of the expandable grip 1. It can be seen in FIG. 13 that in various embodiments the wings 21 are rigid enough to support (or partially support) the weight of the mobile device 9 when being used as a stand. When the wings 21 are centered and somewhat rigid, they increase the angle at which the mobile device 9 sits when standing using the expandable grip 1. On the other hand, if the wings 21 are very flexible, they may collapse and the expandable grip 1 sits at approximately the same angle as that shown in FIG. 5.

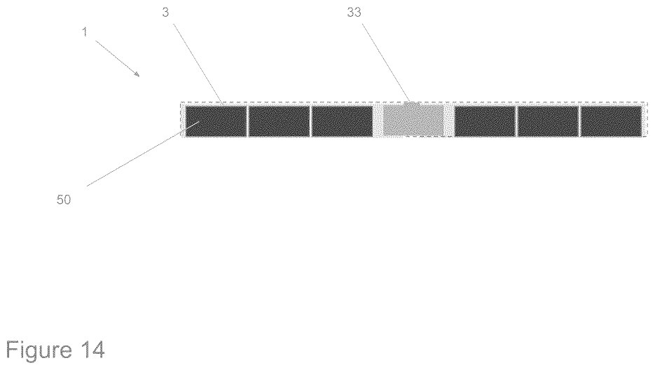

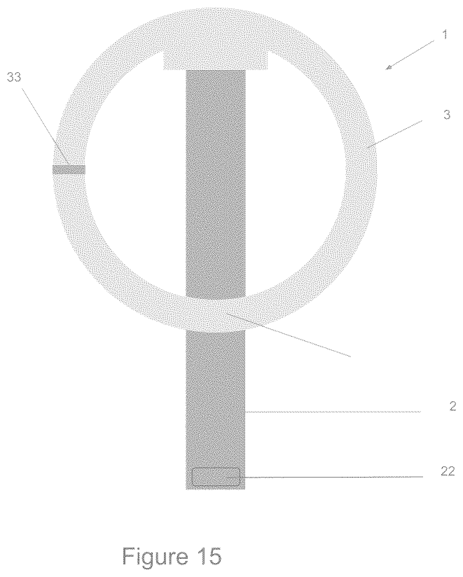

FIG. 14 shows a cross-sectional view of the expandable grip 1 having a plug 33 in accordance with illustrative embodiments. The plug 33 may be within the frame 3. The plug 33 represents a break of some or all metal components in or within the frame 3. This is further illustrated with the top view shown in FIG. 15. The plug 33 maintains the structure of the frame 3 while also creating a gap in the electrical conductivity of the frame 3 and its components. This can be advantageous when considering wireless charging which uses a magnetic field to generate a current inside of the mobile device 9. A full circle of electrical conductive material can act as a coil of wire, disrupting wireless charging. But providing this break in the frame 3 reduces the frame 3 as a potential receptor of electromagnetic waves (although it still may absorb some).

Although the plug 33 may be formed as a physical plastic piece positioned in the frame 3 (e.g., in a discontinuity or gap in the frame 3) in both FIG. 14 and FIG. 15, it can be seen that the plug 33 could be simply a gap in the frame 3 (if it is made out of metal) and the structure of the frame 3 is maintained by the overall stiffness of its material elsewhere in the frame. The plug 33 could also be made out of another material which is non-electrically conductive, such as rubber, ceramic, epoxy, etc.

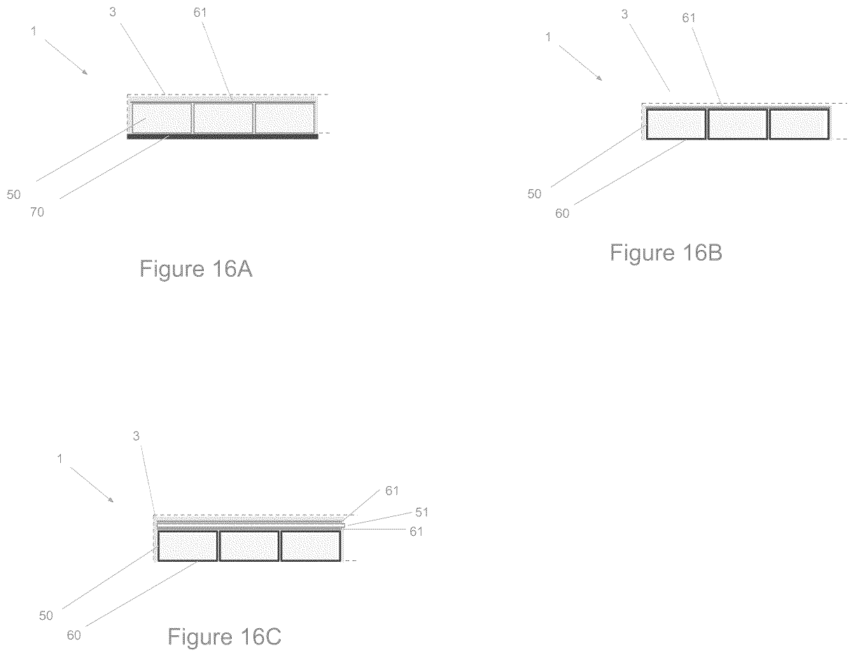

FIGS. 16A-16C illustrate three arrangements for positioning the magnets 50 inside of the frame 3. FIG. 16A shows the magnets 50 positioned in the frame 3 using a chemical attachment 61. The chemical attachment 61 may be glue, epoxy, adhesive or any other thin mechanism to attach two objects. In FIG. 16A a pad 70 is also used pads 70 may be used to help protect the magnets 50, help secure the magnets 50, and to offer a softer or more tactile surface to the mobile device 9.

Alternatively, as shown in FIGS. 16B and 16C, the magnets 50 may be provided with a coating 60 applied to one or more outer surfaces. The coating 60 may comprise a material selected to enhance surface properties of the magnet 50, including but not limited to improved adhesion, scratch resistance, softness, visual appearance, and shock absorption. On the bottom surface of the magnet 50 (i.e., the surface facing the mobile device 9), the coating 60 may serve similar functional purposes as a separate pad component (Pad 70), but with significantly reduced thickness. For example, while a pad 70 may have a thickness ranging from approximately 0.1 mm to 0.4 mm, the coating 60 may have a thickness in the range of approximately 0.001 mm to 0.050 mm.

The reduced thickness of the coating 60 provides several advantages. First, it enables a lower overall profile for the expandable grip 1, which may be beneficial for both aesthetic and ergonomic considerations. Second, the thinness of the coating minimizes the amount of material positioned between the magnet 50 and the mobile device 9 (or an associated case or ferromagnetic adapter), thereby reducing magnetic flux resistance and enhancing magnetic coupling strength. This can result in more reliable attachment to devices utilizing integral magnets 500 (e.g., MagSafe-compatible phones or accessories).

Furthermore, when applied to the top surface of the magnet 50 (i.e., the surface opposite the mobile device), the coating 60 may promote improved bonding to a chemical attachment 61 (e.g., a chemical adhesive) or other attachment medium. In various embodiments, the coating 60 adheres more effectively than traditional magnet finishes or platings, such as nickel or epoxy, thereby contributing to increased manufacturing reliability and product durability.

FIG. 16C shows an embodiment of the expandable grip that uses the shim 51. It can be seen that in this case the magnets 50 have a coating 60 that is chemically attached 61 to a shim 51 which is then chemically attached 61 to the frame 3. The chemical attachments 61 in the diagram may be the same process or different (i.e. the shim 51 may have an adhesive on one side and glue on the other).

The coating 60 shown in FIGS. 16B and 16C could be any coating which is thin and increases the desired characteristics of the magnet 50 surface. Examples include epoxy coatings, Xylan, Everlube, Teflon, etc.

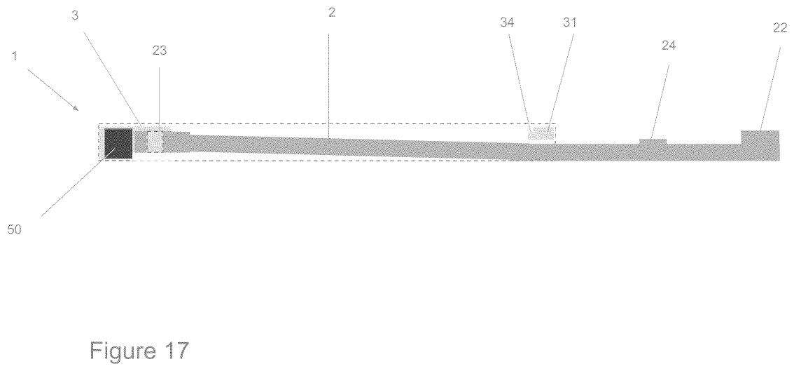

FIG. 17 shows another embodiment of the expandable grip 1 in accordance with illustrative embodiment. FIG. 17 is similar to that in FIG. 2, except that a small lock 24 has been added to the strap 2. The lock 24 may be similar to the stop 22. However, the lock 24 is sized to fit under the bridge 31 (or through the channel). The lock 24 may be sized to fit under the bridge 31 or could even push the bridge 31 slightly up in order to slip under it. For example, the lock 24 may have a ramped surface facing towards the bridge 31.

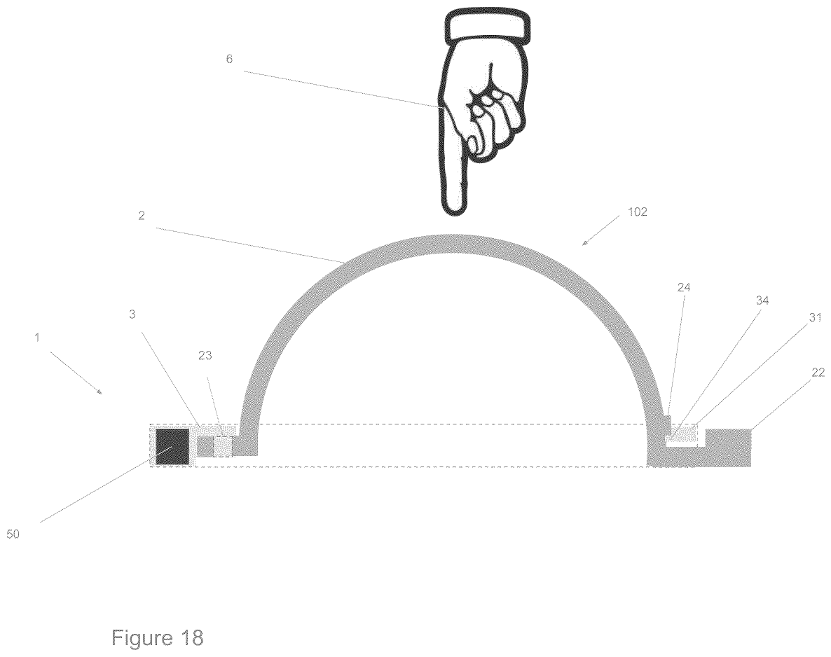

FIG. 18 schematically shows a user operation the expandable grip of FIG. 17 in accordance with illustrative embodiments. After the expandable grip 1 is in the expanded configuration, the lock 24 becomes mechanically obstructed by the bridge 31 because of the way the strap 2 is bent into an arc the expanded configuration. This obstruction helps prevent the expandable grip 1 from accidentally collapsing (i.e. it becomes “locked” in the expanded configuration). Forces which are exerted on the top of the expanded strap 2, such as from a user 6 or “stand mode”, do not easily push the expandable grip 1 into its collapsed position. The interaction between the lock 24 and the frame 3 resists the strap 2 from returning towards the collapsed configuration. Also seen in FIG. 17 and FIG. 18, a thinner or chamfered area bridge hook 34 may be added to the bridge 31 in order to aid in the mating of the lock 24 to the bridge 31/bridge hook 34.

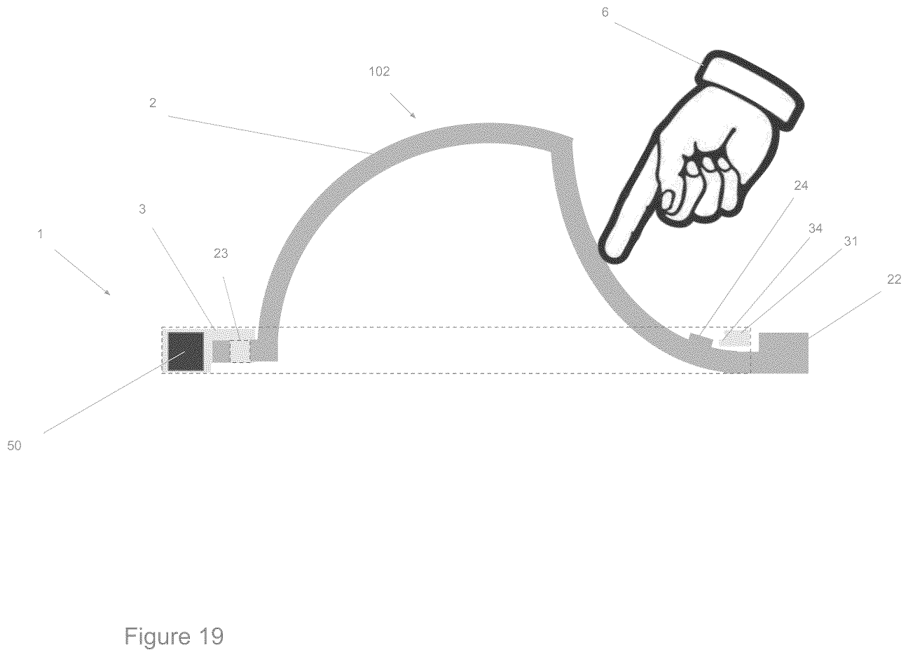

To transition the expandable grip 1 into the collapsed configuration in embodiments including the lock 24 feature, the user 6 may apply a deforming force to the side of the strap 2, as illustrated in FIG. 19. This deformation flattens the portion of the strap 2 that includes the lock 24, thereby eliminating the mechanical interference between the lock 24 and the bridge 31/bridge hook 34. As a result, the lock 24 is able to pass back under the bridge 31 and the associated hook 34, permitting the strap 2 to return to the collapsed configuration.

The lock 24 advantageously makes the expandable grip 1 more stable in its expanded configuration. This makes holding and standing the expandable grip 1 more reliable with reduced likelihood that it may suddenly enter the collapsed configuration. Much like the stop 22, the lock 24 may be integrally formed into the strap 2 or it may be a separate part which is attached to the strap 2. The bridge 31 or bridge hook 34 shape may also be modified in order to more effectively mate with the corresponding lock 24 feature.

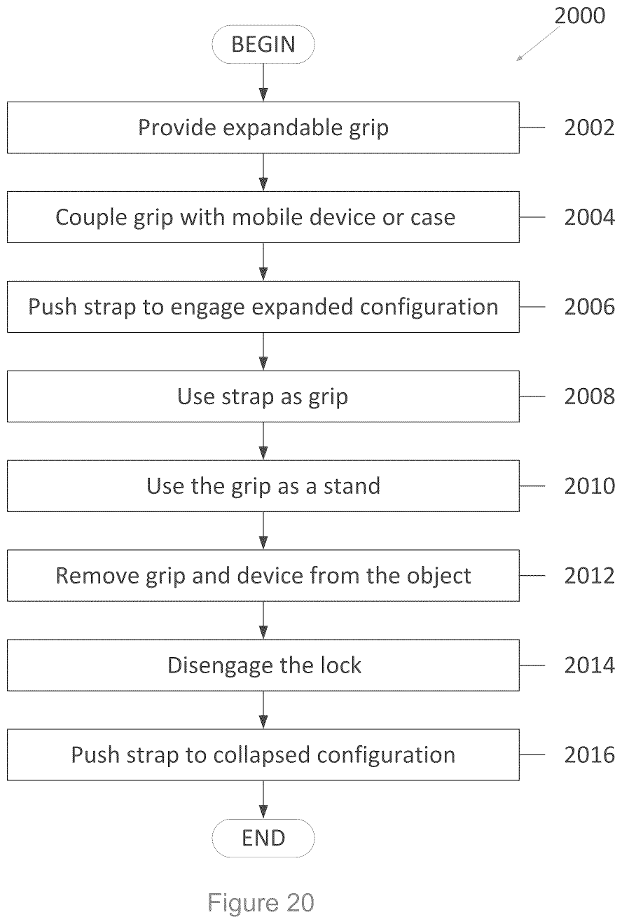

FIG. 20 shows a process of using the expandable grip 1 in accordance with illustrative embodiments of the invention. It should be noted that this method is substantially simplified from a longer process that may normally be used. Accordingly, the method shown in FIG. 20 may have many other steps that those skilled in the art likely would use. In addition, some of the steps may be performed in a different order than that shown, or at the same time. Furthermore, some of these steps may be optional in some embodiments. Accordingly, the process 2000 is merely exemplary of one process in accordance with illustrative embodiments of the invention. Those skilled in the art therefore can modify the process as appropriate.

The process begins at step 2002, which provides the expandable grip 1. The method of use disclosed herein may begin with any suitable embodiment of the expandable grip 1, including but not limited to those illustrated in FIGS. 1 through 19. The grip may correspond to any of the specific embodiments shown, or may include one or more features described with respect to any of those figures.

The expandable grip 1 includes a repositionable strap 2 that transitions between a collapsed configuration and an expanded configuration. The strap 2 is movable between a collapsed configuration and an expanded configuration, corresponding respectively to a stowed state and a usable state. The grip 1 may further include various optional components such as a lock 24, stop 22, wings 21, and a magnet array 50. In various embodiments, the expandable grip 1 may be formed by combining structural or functional elements from multiple illustrated embodiments, and the scope of the invention is not limited to any single configuration depicted in the figures. The grip may be a standalone accessory or integrated into a mobile device case. The grip's components may be formed from a combination of materials, including plastic, metal, or elastomeric elements, and may be assembled to provide a low-profile form factor suitable for magnetic attachment and user engagement.

At step 2004, the grip 1 is coupled with the mobile device 9 (or the case of the mobile device 9). As described previously, however, the grip 1 may be formed as part of the case of the mobile device 9. In some embodiments, the grip 1 may be formed as part of the mobile device 9.

As shown in FIGS. 4 and 10A-10B, the grip 1 may magnetically couple to the mobile device 9 via internal magnets 50, which align with corresponding integral magnets 500 embedded within the device 9 (e.g., MagSafe-enabled phones) or within a magnetic case or adapter. For example, the magnets 50 in the grip 1 may be aligned with magnets 500 in the device 9 to magnetically couple. The grip 1 may also attach directly to the case if it includes a ferromagnetic insert or magnetic ring. Alternative or additional attachment mechanisms, such as adhesives or mechanical fasteners, may also be used to couple the grip 1 with the device 9. As used in this application, the term “mobile device” broadly encompasses both the device and any associated case, unless otherwise specified.

At step 2006, the strap 2 is pushed to engage the expanded configuration. With the grip 1 coupled to the device 9, the user 6 may apply force to the strap 2 to move it from the collapsed configuration to the expanded configuration. As shown in FIG. 1 and discussed in connection with FIGS. 3A-3B, the strap is pushed through the bridge 31 or channel within the frame 3, forming a raised loop. This action may be performed using a single hand (e.g., a single finger, such as the thumb), and the strap 2 may be guided under the bridge 31 without the need for complex manipulation. In some embodiments, the stop 22 prevents the strap 2 from being overextended, while allowing it to form a loop suitable for user engagement. Additionally, a lock 24 may be configured to prevent the strap 2 from inadvertently returning to the collapsed configuration shown in FIG. 1. To that end, the lock 24 may work in conjunction with the bridge hook 34.

At step 2008, when the strap 2 is in the expanded configuration, the user 6 may insert a finger into the loop to hold the device 9 securely, as shown in FIG. 4. This enhances device stability during use, particularly during tasks such as texting, browsing, or photographing. Alternatively, in embodiments featuring wings 21 (e.g., shown in FIGS. 8-9), the user 6 may grip the wings 21 directly instead of inserting a finger through the loop. This configuration may be especially useful when holding the phone sideways, such as when taking a selfie or recording video. In some designs, the grip 1 is configured so that the wings 21 position is centered when the grip 1 is expanded for optimal ergonomics.

At step 2010, the grip 1 is used as a stand. The expanded strap 2 may also function as a stand, propping up the mobile device 9 on a flat surface 8, as shown in FIG. 5. The strap 2, which may be semi-rigid or reinforced, supports the device at an angle suitable for hands-free viewing. Additionally, as shown in FIG. 13, if wings 21 are sufficiently rigid and centrally located in the expanded configuration, they may also assist in supporting the device in a stand mode. The grip 1 may also serve as a stand by magnetically coupling both the grip and device to an external ferromagnetic surface (e.g., a refrigerator or gym machine), as depicted in FIG. 11. In this scenario, the grip 1 maintains the device in a stable, suspended position.

At step 2012, the grip may be removed from the object 10, if it was magnetically coupled thereto. When the device is magnetically attached to an external object (Block 10), the user 6 may remove the grip 1 and device 9 together by applying a pulling force F1, as illustrated in FIG. 11. The grip's internal shim 51 (FIG. 10B) helps to regulate the magnetic field such that the coupling force F2 between the grip 1 and the mobile device 9 exceeds the force F3 between the grip 1 and the external object 10. This ensures that the grip 1 remains attached to the phone 9 during removal, rather than detaching and staying stuck to the external surface.

At step 2014 the lock 24 is disengaged. Various embodiments include the lock 24 (e.g., as shown FIGS. 17-19), the user 6 may press or deform the strap 2 in a specific manner to flatten the region containing the lock. This disengages the lock 24 from the frame 3 (e.g., the bridge 31 or bridge hook 34), eliminating mechanical interference and allowing the strap 2 to return to the collapsed configuration. The interaction between the lock 24 and bridge 31 helps to prevent unintentional collapse, enhancing reliability when the grip 1 is in use. Deformation of the strap 2 may involve applying localized pressure to the strap 2 towards the center, depending on the geometry of the lock 24.

At step 2016 the user 6 may push or guide the strap 2 fully back into the frame 3, transitioning the grip 1 back to the collapsed configuration, as shown in FIG. 2. In this stowed state, the strap 2 lies substantially flush with the surface of the mobile device 9 or case. The grip 1 does not form a finger loop and presents a low-profile design that reduces bulk, improves aesthetics, and may be compatible with wireless charging and pocket storage. If the magnets includes a thin coating 60 (see FIGS. 16B-16C), this further reduces overall thickness and preserves magnetic performance. In various embodiments, the total thickness T_{C} in the collapsed configuration is 2.2 mm-3 mm. In general, it is desirable for the total thickness T_{C} in the collapsed configuration to be less than 3 mm. Various embodiments may achieve the total thickness T_{C} in the collapsed configuration of less than 2 mm (e.g., the coating of the magnet may be 10-25 microns). For example, some embodiments may operate as a grip and not be configured to operate as a stand. The strap may be made very thin, reducing the overall thickness in the collapsed configuration T_{C} down to about 1.5 mm, or less.

The illustrative embodiments described herein primarily relate to expandable grips that include a strap or loop-forming member. However, the structural and functional features disclosed—such as magnetic coupling mechanisms, field-modulating shims, attachment structures, locking elements, wing projections, and wireless charging accommodations—may be implemented in a variety of mobile device grip designs, including those that do not utilize a strap. For example, alternative grips may include pop-out tabs, rigid loops, sliding panels, elastic arrays, or hingedly deployable arms. Accordingly, the disclosed components and methods are not limited to strap-based grips, and may be adapted to operate with other forms of expandable or collapsible mobile accessories. The scope of the invention is therefore not limited to any particular style of grip unless expressly stated.

It should be apparent that illustrative embodiments provide a number of advantages, including a very thin grip and many functional features of larger mobile accessories. However, large mobile accessories often provide increased thickness but allow users to grip their mobile devices or support their phones on flat surfaces. However, such accessories typically introduce significant bulk, creating uneven surfaces that interfere with pocketability and the size may interfere with wireless charging functionality. These trade-offs make them impractical for everyday use, especially for users seeking a minimal, sleek profile.

Illustrative embodiments of the expandable grip described herein address these limitations by providing a low-profile accessory that can expand rapidly and easily to form a larger, functional structure for gripping or supporting the device. When not in use, the grip collapses into a compact configuration, preserving the slim form factor of the phone and maintaining compatibility with wireless charging systems. Moreover, in various embodiments, the accessory includes magnetic coupling features that allow the phone to be securely attached to external ferromagnetic surfaces, such as refrigerators or gym equipment, further extending its utility in hands-free environments.

As used in this specification and the claims, the singular forms “a,” “an,” and “the” refer to plural referents unless the context clearly dictates otherwise. For example, reference to “the magnet” in the singular includes a plurality of magnets, and reference to “the lock” in the singular includes one or more locks and equivalents known to those skilled in the art. Thus, in various embodiments, any reference to the singular includes a plurality, and any reference to more than one component can include the singular.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein.

It is, therefore, to be understood that the foregoing embodiments are presented by way of example only and that, within the scope of the appended claims and equivalents thereto, inventive embodiments may be practiced otherwise than as specifically described and claimed. Illustrative embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure. Disclosed embodiments, or portions thereof, may be combined in ways not listed above and/or not explicitly claimed. Thus, one or more features from variously disclosed examples and embodiments may be combined in various ways. For example, it is to be understood that the present disclosure contemplates that, to the extent possible, one or more features of any embodiment can be combined with one or more features of any other embodiment.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Although the above discussion discloses various exemplary embodiments of the invention, it should be apparent that those skilled in the art can make various modifications that will achieve some of the advantages of the invention without departing from the true scope of the invention.

What is claimed is:

1. A grip for a mobile device comprising:
a frame having at least one magnet for coupling the grip to a mobile device or a case of a mobile device;
a strap configured to transition from a collapsed configuration to an expanded configuration where the strap forms a loop configured to receive a user's finger;
wherein the frame defines a partially enclosed opening through which the strap is configured to pass to transition from the collapsed configuration to the expanded configuration.

2. The grip of claim 1, wherein the frame is configured so that an enclosed opening is defined by a surface of a mobile device or a case of the mobile device when (a) the frame and (b) the mobile device or the case of the mobile device are magnetically coupled.

3. The grip of claim 1, wherein the device is configured so that the strap is surrounded by a mobile device when the strap is in the opening and when the grip is coupled to the mobile device.

4. The grip of claim 1, further comprising a ferromagnetic shim disposed between the magnet and a top surface of the frame.

5. The grip of claim 1, further comprising a lock configured to engage a portion of the frame in the expanded configuration.

6. The grip of claim 1, further comprising wings extending laterally from the strap.

7. The grip of claim 1, wherein the magnet is coated with an epoxy layer having a thickness of between about 0.005 mm and about 0.05 mm.

8. The grip of claim 1, wherein the strap is secured to the frame via a rivet.

9. The grip of claim 1, wherein the frame is formed as a circular conductive structure that includes a non-metallic gap or insert configured to interrupt the electrical path around the circumference of the structure.

10. The grip of claim 1, wherein a total thickness of the grip in the collapsed state is 3 mm or less.

11. A method of operating an expandable grip for a mobile device, the method comprising:
providing an expandable grip, the expandable grip having:
a base configured to couple with a mobile device or a case of a mobile device,
a strap being partially retained within the base and movable between a collapsed configuration in which the strap is collapsed and an expanded configuration in which the strap forms a loop;
coupling the expandable grip to a mobile device or case;
transitioning from the collapsed configuration to the expanded configuration.

12. The method of claim 11, wherein transitioning comprises applying a force to the strap using a finger of a user to reposition the strap from the collapsed configuration to the expanded configuration.

13. The method of claim 12, wherein applying the force to the strap comprises pressing or sliding the strap through an opening in the base using a single finger.

14. The method of claim 11, further comprising inserting a finger into the loop.

15. The method of claim 11, further comprising using the strap in the expanded configuration to support the mobile device in an inclined position on a flat surface.

16. The method of claim 11, wherein the grip includes a locking feature configured to resist return to the collapsed configuration, and further comprising:
deforming a portion of the strap to disengage the locking feature; and
returning the strap to the collapsed configuration.

17. The method of claim 11, further comprising magnetically coupling the expandable grip and mobile device to an external ferromagnetic surface for hands-free use.

18. A system comprising:
a mobile device or case of a mobile device having a device magnetic coupling portion;
a grip for use with the mobile device or the case associated with the mobile device, the grip having:
a frame having a bridge,
a corresponding magnetic coupling portion housed within the frame,
a strap being coupled to the frame and movable between:
(i) a collapsed configuration in which the strap lies substantially flat, and
(ii) an expanded configuration in which the strap forms a loop, and
an opening through which the strap is configured to pass to transition between an expanded configuration and a collapsed configuration, the opening formed at least in part by the bridge portion and a surface of the mobile device or the case of the mobile device when the grip and the mobile device or the case of the mobile device are magnetically coupled.

19. The system of claim 18, wherein the grip includes a ferromagnetic shim disposed between the magnet coupling portion and a top surface of the frame.

20. The system of claim 18, wherein the strap includes a lock configured to engage a portion of the frame in the expanded configuration.
